(19) United States
(12) Patent Application Publication
(10) Pub. No.: US 2013/0322091 A1
(43) Pub. Date: Dec. 5, 2013

(54) LAMP ACCENT ASSEMBLY AND METHOD

(71) Applicants: Kenneth W. Honeycutt, Houston, TX (US); Anthony J. Gutierrez, Houston, TX (US)

(72) Inventors: Kenneth W. Honeycutt, Houston, TX (US); Anthony J. Gutierrez, Houston, TX (US)

(21) Appl. No.: 13/486,748

(22) Filed: Jun. 1, 2012

(51) Int. Cl. F21V 13/04; H01R 43/00; F21V 7/00

(52) U.S. Cl. 362/319; 29/825

(57) ABSTRACT

The present disclosure describes a light accent assembly. The light accent assembly may include a reflector body. The light accent assembly may also include a collar proximate to a top of the reflector body. The collar may be operable to removably couple to an LED lamp and the reflector body may be operable to removably couple to the collar. The light accent assembly may also include a trim proximate to a bottom of the reflector body. The trim may define a bottom opening through which light generated by the LED lamp is directed.

### FIELD

Embodiments described herein related generally to a downlight accent assembly and methods of manufacturing the same.

### BACKGROUND

Typical downlight fixtures are recessed into a ceiling. Holes in the surface of the ceiling are usually cut to provide an opening through which light from the fixture can enter the room. A finishing trim may be attached to the inside of the fixture and cover the cut-out, providing a finished, professional look. Recently, environmentally friendly light sources, such as LED lamps, have been replacing traditional sources—including incandescent, halogen, and florescent lamps—in downlight applications. Unfortunately, utilizing LED lamps within a recessed light fixture has typically meant replacing the entire light fixture to accommodate the LED drivers and power supplies, or utilizing a dedicated retrofit model or trim assembly incorporating an LED source, which requires that the light fixture trim be changed for installation.

### BRIEF DESCRIPTION OF THE DRAWINGS

Some specific exemplary embodiments of the disclosure may be understood by referring, in part, to the following description and the accompanying drawings.

FIG. 1a shows a front view of an example light accent assembly incorporating aspects of the present disclosure.

FIG. 1b shows a cross section of the example light accent assembly shown in FIG. 1a.

FIG. 2a shows an expanded isometric view of an example light accent assembly incorporating aspects of the present disclosure.

FIG. 2b shows a cross section of the example light accent assembly shown in FIG. 2a.

FIG. 3 shows an example light accent assembly installed within an example downlight fixture, according to aspects of the present disclosure.

FIG. 4 shows an example light accent assembly installed within an example downlight fixture, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Embodiments described herein related generally to a downlight accent assembly and methods of manufacturing the same.

Hereinafter, embodiments will be described with reference to the drawings. Each drawing is a schematic view for describing an embodiment of the present disclosure and promoting the understanding thereof. The drawings should not be seen as limiting the scope of the disclosure. In each drawing, although there are parts differing in shape, dimension, ratio, and so on from those of an actual apparatus, these parts may be suitably changed in design taking the following descriptions and well-known techniques into account.

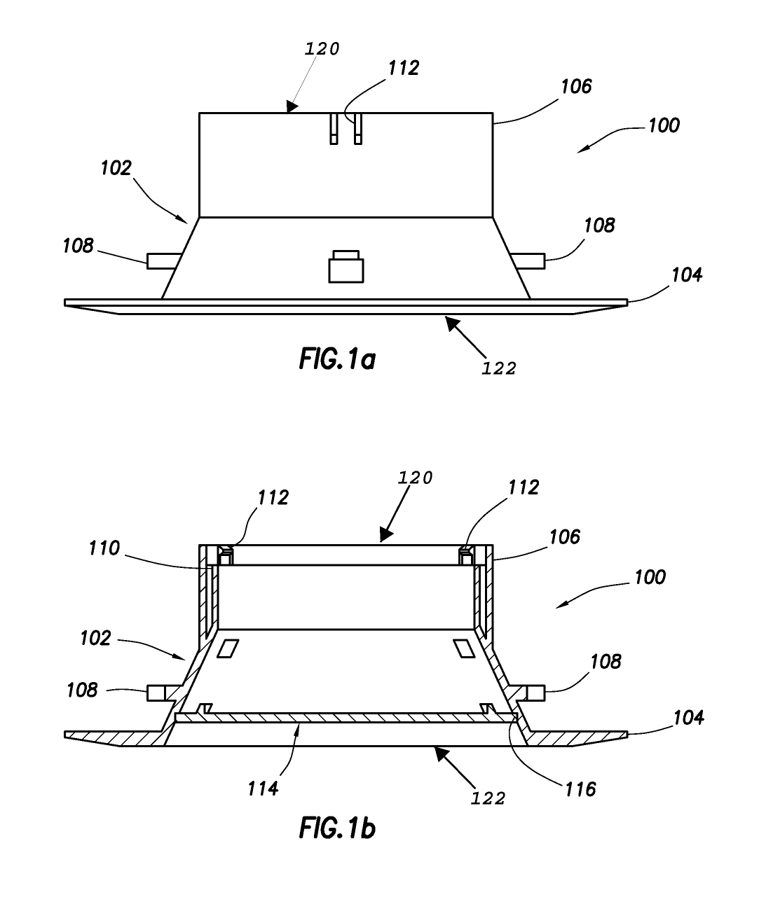

FIGS. 1a and 1b show a light accent assembly 100 incorporating aspects of the present disclosure. As can be seen, the light accent assembly 100 includes a reflector body 102, a trim 104, and a collar 106. The reflector body 102 may include a generally conical shape, and may define an inner chamber through which light from an LED light source is directed. The trim 104 may comprise a downlight fixture finishing trim comprising a flat, annular shape that is proximate to a bottom of the reflector body 102 and may be integral with or removable coupled to the reflector body 102. In the embodiment shown in FIGS. 1a and 1b, the trim 104 is integral with the reflector body 102 and defines a bottom opening 122 of the light accent assembly 100. The reflector body 102 and the trim 104 may be manufactured, for example, out of plastic or other materials as would be appreciated by one of ordinary skill in view of this disclosure.

The collar 106 may be proximate to a top of the reflector body 102, and may define a top opening 120 in the light accent assembly 100. The collar 106 may comprise a cylindrical shape that defines an inner opening into which an LED lamp may be at least partially inserted and through which the light from an inserted LED lamp may be directed. In particular, the top opening 120 may be sized to accommodate the bottom portion of a LED lamp, as can be seen in FIG. 3. The collar 106 may be integral with or may be removably coupled to the reflector body. In the embodiment shown in FIGS. 1a and 1b, the collar 106 is integral with the reflector body 102. The reflector body 102, trim 104, and collar 106 may be manufactured, for example, out of plastic or other materials as would be appreciated by one of ordinary skill in view of this disclosure.

The collar 106 may removably coupled to an LED lamp (not shown). In the embodiment shown, the collar 106 may be removably coupled to an LED lamp via a snap-fit engagement using tabs 112 and shoulder 110. In particular, an LED lamp may be inserted into the top opening 120, such that the LED lamp is positioned to shine light into the reflector body 102 and out through the bottom opening 122. Once inserted, the LED lamp may contact the shoulder 110. Once the LED lamp has contacted the shoulder 110, tabs 112 of the collar 106 may snap around an integral ring of the LED lamp, locking the LED lamp into the collar 106 via a snap-fit engagement. The LED lamp may be removed from the collar 106 by releasing the tabs 112 and pulling the LED lamp out of the collar 106.

Advantageously, because the light accent assembly 100 includes a collar 106 that is operable to removably couple to an LED lamp, the light accent assembly 100 may be optional. In contrast to existing LED lamp downlight retrofits—which typically require that the reflector/trim be changed, or utilize a non-standard LED light source—aspects of the present application may allow for a standard LED lamp to be installed alone in place of a traditional incandescent lamp, utilizing the existing reflector and trim. Should a retrofit or upgrade be desirable for a given downlight or room, a light accent assembly, such as light accent assembly 100 may be attached to the existing LED lamp, instead of requiring an additional retrofit module.

In certain embodiments, the light accent assembly 100 may further include a lens 114. The lens 114 may be installed within and removable from the reflector body 102. The lens 114 may act as a diffuser, diffusing the light from the LED lamp before the light exits the light accent assembly 100 through the bottom opening 122. The lens 114 may be at least partially disposed in a notch 116 within the reflector body 102. The lens may include tabs 124 that engaged with a lip in the reflector body 102, as will be discussed below. In certain embodiments, the lens may comprise a concave plastic disk that has varying levels of opaqueness depending on the application.

In certain embodiments, the light accent assembly 100 may further include a wireform housing 108 disposed on an outer surface of the reflector body 102. The wireform housing 108 may hold a retention spring or wireform, as shown in FIG. 3, that may secure the light accent assembly within a downlight fixture. The retention wireform may urge the trim 104 upwards relative to a downlight fixture, pulling the trim flush with the ceiling. By pulling the trim 104 flush with the ceiling, the light accent assembly may provide a professional, finished look.

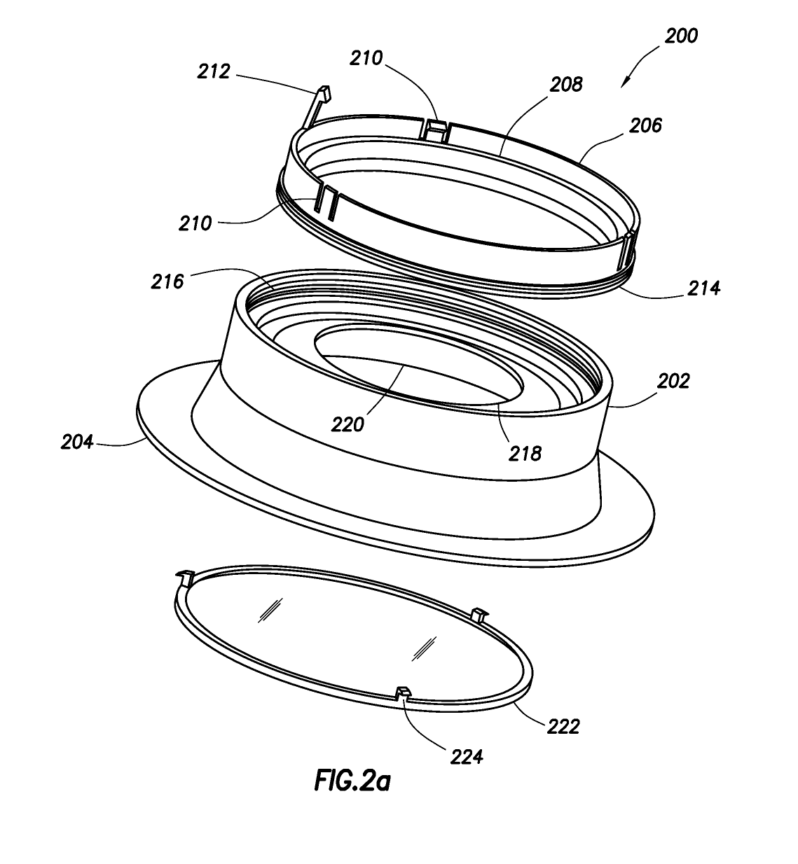

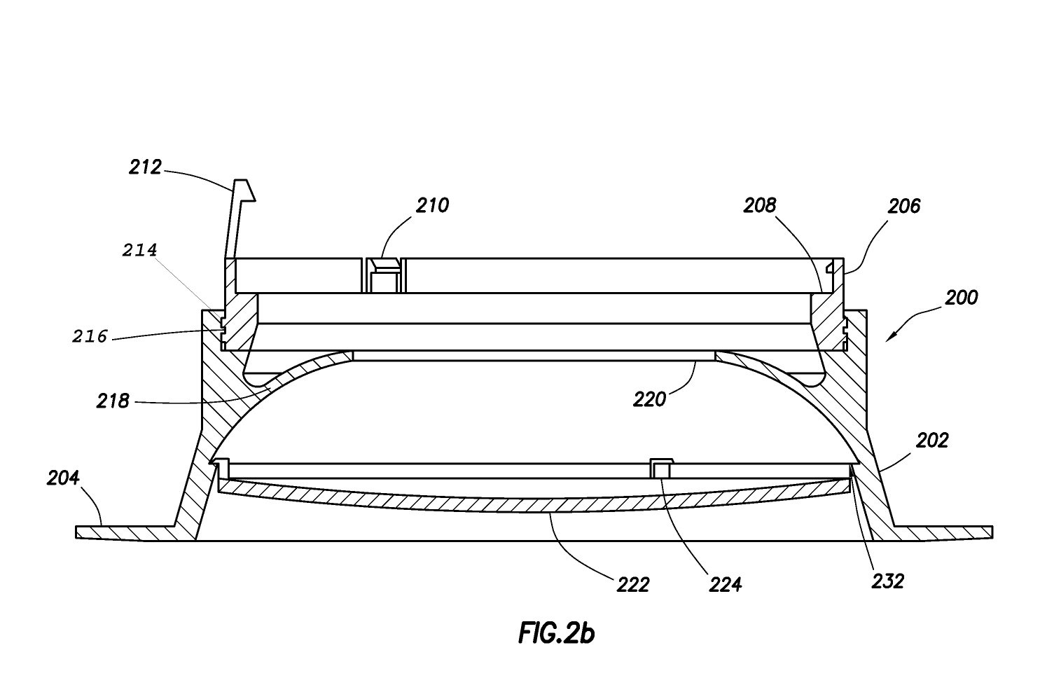

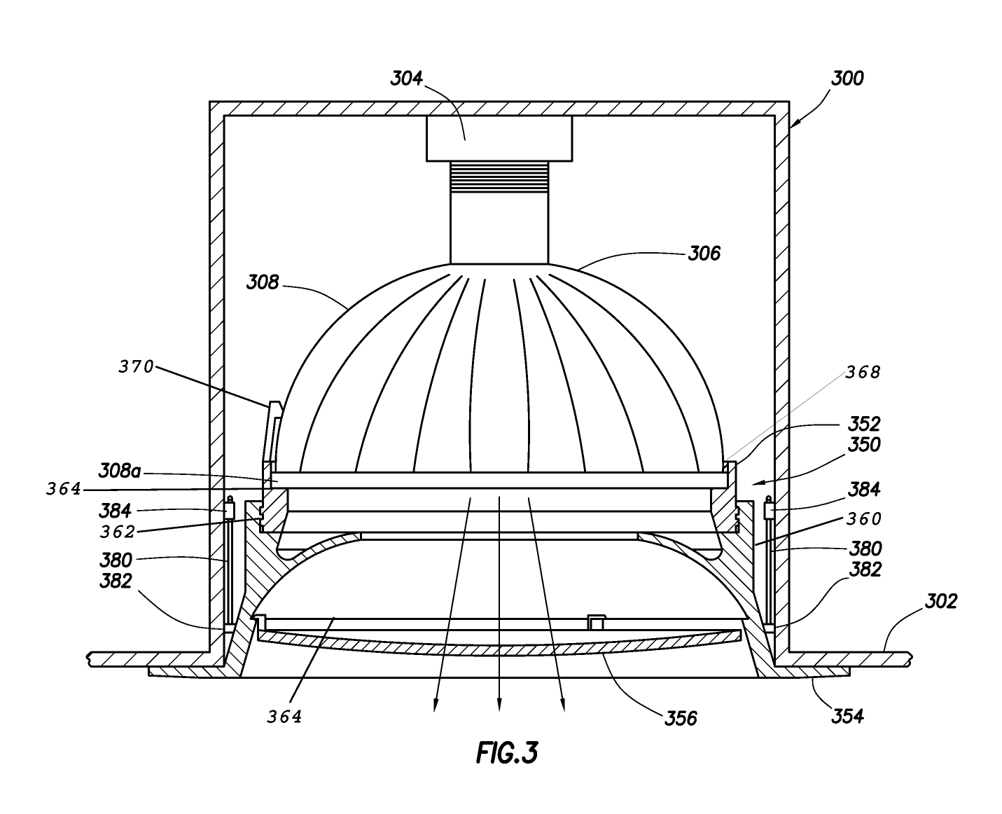

FIGS. 2a and 2b show an example light accent assembly 200, incorporating aspects of the present disclosure. The light accent assembly 200 may include a reflector body 202, a trim 204 integral with the reflector body 202, and a collar 206 that may be removably coupled to the reflector body 202. As can be seen, the collar 206 may be coupled to the reflector body 202 proximate to a top of the reflector body 202. The collar 206 may include threads 214 on an outer surface of the collar 206 that correspond to threads 216 within the reflector body 202. The collar 206 may be removably coupled to the reflector body 202 using the threads 214 and 216. Although threads are shown, other attachment mechanisms are possible to removably couple the collar 206 to the reflector body 202. For example, tabs may be incorporated into either the reflector body 202 or collar 204 to couple the reflector body 202 and collar 204.

Like collar 106 from FIGS. 1a and 1b, collar 206 may be removably coupled to an LED lamp via a snap-fit engagement using shoulder 208 and tabs 210. Also like collar 106, collar 206 may comprise a cylindrical shape that defines an inner opening into which an LED lamp may be at least partially insert and through which the light from an inserted LED lamp may be directed. Unlike light accent assembly 100 in FIGS. 1a and 1b, however, where the entire assembly is integral and coupled to the LED lamp at the same time, light accent assembly 200 allows for the collar 206 to be attached to the LED lamp separately, and then the reflector body 202 and trim 204 coupled to the collar 206 via threads 214 and 216. The separate collar 206 may be advantageous because it may allow for the interchangeability of reflectors and trims with different heights and designs.

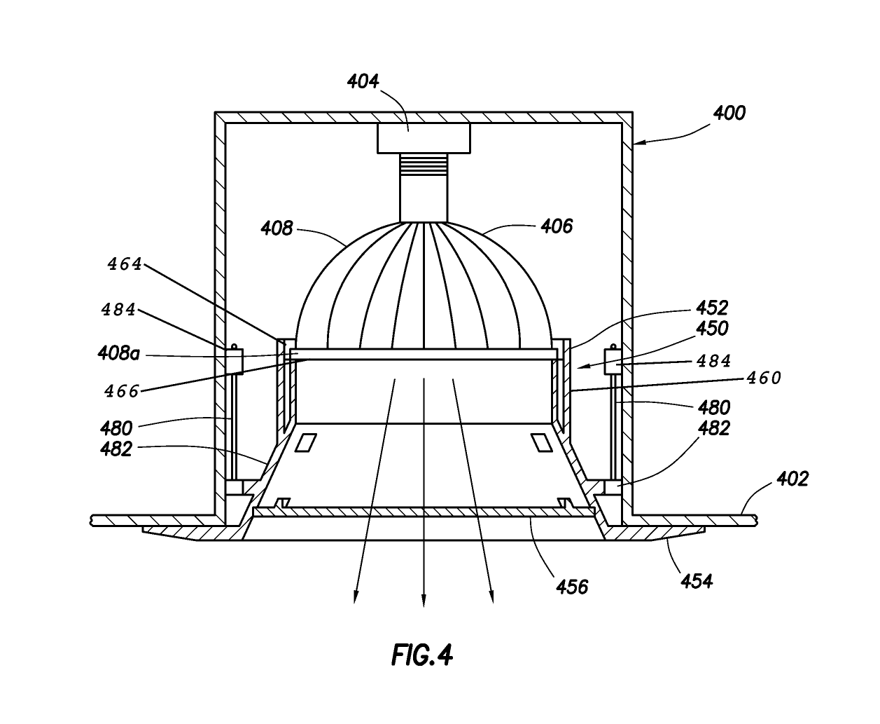

In certain embodiments, the collar 206 may include a locking tab 212, which extends from a top surface of the collar 206. The locking tab 212 may engage with fins on an outer surface of the LED lamp, as will be shown in FIGS. 3 and 4, when the LED lamp is engaged with the collar 206. The locking tab 212 may prevent rotational movement of the collar 206 relative to the LED lamp to facilitate the threading of the reflector body 202 to the collar 206 once the collar 206 is coupled to the LED lamp.

In certain embodiments, the reflector body 202 may include a lamp vent cover 218. The lamp vent cover 218 may comprise an annular projection from an interior surface of the reflector body that defines an opening 220. LED lamps may include vents on a bottom facing surface of the LED lamp, surrounding the light source. The opening 220 may be sized to correspond to the size of the light source of the LED lamp, allowing the light to travel into the reflector body 202 and through lens 222 while blocking the view of the LED lamp vents. In certain embodiments, the lamp vent cover 218 may be offset from the bottom face of the LED lamp to allow airflow into the LED lamp. Advantageously, the lamp vent cover 218 may increase the aesthetic appeal of the downlight fixture by preventing or limiting the view of the lamp vents from below.

As can be seen in FIG. 2b, the reflector body may include an internal lip 232. The internal lip 232 may engage with tabs 224 of a lens 222, retaining the lens within the reflector body 202 via a snap-fit engagement. The lens 222 may be inserted into and removed from the reflector body 202 via the tabs 224. The lens 222 may have a diffusion effect as described above and may be convex, concave, or flat, depending on the application. The lens 222 could also be a different color or contain some refractive geometry on the lens surface in order to affect light distribution or any other optical properties or performance.

FIG. 3 shows an example light accent assembly 350 installed within an example downlight fixture 300, according to aspects of the present disclosure. The light accent assembly 350 may be similar to the light accent assembly 200 from FIGS. 2a and 2b. In particular, light accent assembly 350 may include reflector body 360 and trim 354, and a separate collar 352 removably coupled to the reflector body 360 through threads 362. The light accent assembly 350 may also include a diffusion lens 356 in a snap-fit engagement with a lip 364 of the reflector body 360. As can be seen, the downlight fixture 300 may be installed above a ceiling structure 302. The ceiling 302 may include an opening corresponding to the location of the downlight fixture 300, so that light from the LED lamp 306 positioned within the fixture 300 may enter the target area. The LED lamp 306 may be installed with a socket 304 of the downlight fixture 300, in which traditional light sources may also be installed.

As can be seen, the LED lamp 306 may include fins 308 and an integral ring 308a. The LED lamp 306 may be removably coupled to the collar 352. When coupled, the LED lamp 306 may be in a snap-fit engagement with the collar 352, with the LED lamp 306 contacting a shoulder 366 of the collar 352, and tabs 368 of the collar 352 engaged with the integral ring 308a of the LED lamp 306. Additionally, a locking tab 370 of the collar 352 may engage with the fins 308 of the LED lamp 306, preventing the collar 352 from rotating around the LED lamp 306 once they are coupled together.

As can also be seen, the downlight fixture 300 may include mounting features 384. In certain embodiments, the mounting features may correspond to mounting retention wireforms 380 coupled to the reflector body via wireform housings 382. In certain embodiments, the spring or wireforms 380 may be compressed during installation and inserted into the mounting features 384. Once inside the mounting features 384, the retention wireforms 380 may expand, pulling the light accent assembly 350 upwards, securing the trim 354 against the ceiling 302.

FIG. 4 shows an example light accent assembly 450 installed within an example downlight fixture 400, according to aspects of the present disclosure. The light accent assembly 450 may be similar to the light accent assembly 100 from FIGS. 1a and 1b. In particular, light accent assembly 450 may include and integral reflector body 460, trim 454, and collar 452. The light accent assembly 450 may also include a diffusion lens 456. As can be seen, the downlight fixture 400 may be installed above a ceiling 402 in a given structure. The ceiling 402 may include an opening corresponding to the location of the downlight fixture 400, so that light from the LED lamp 406 positioned within the fixture 400 may enter the target area. The LED lamp 406 may be installed with a socket 404 of the downlight fixture 400, in which traditional light sources may also be installed.

As can be seen, the LED lamp 406 may include fins 408 and an integral ring 408a. The LED lamp 406 may be removably coupled to the light accent assembly 450 via collar 452. When coupled, the LED lamp 406 may be in a snap-fit engagement with the collar 452, with the LED lamp 406 contacting a shoulder 466 of the collar 452, and tabs 468 of the collar 452 engaged with the integral ring 408a of the LED lamp 406.

As can also be seen, the downlight fixture 400 may include mounting features 484. In certain embodiments, the mounting features may correspond to retention wireforms 480 coupled to the reflector body via retainers 482. In certain embodiments, the retention wireforms 480 may be compressed during installation and inserted into the mounting features 484. Once inside the mounting features 484, the retention wireforms 480 may expand, pulling the light accent assembly 450 upwards, securing the trim 454 against the ceiling 402.

While certain embodiments of a light accent assembly have been described, these embodiments have been presented by way of example only, and are not intended to limit the scope of the disclosure. Indeed, the novel systems described herein may be embodied in a variety of other forms; furthermore, various omissions, substitutions and changes in the form of the systems described herein may be made without departing from the spirit of the disclosure. The accompanying claims and their equivalent are intended to cover such forms or modifications as would fall within the scope and spirit of the disclosure.

What is claimed is:

1. A light accent assembly, comprising:
a collar operable to removably couple to an LED lamp;
a reflector body operable to removably couple to the collar; and
a trim proximate to a bottom of the reflector body, wherein the trim defines a bottom opening through which light generated by the LED lamp is directed.

2. The light accent assembly of claim 1, further comprising a diffusion lens, wherein the diffusion lens includes at least one tab.

3. The light accent assembly of claim 2, further comprising a retention wireform coupled to an external surface of the reflector body, wherein the retention wireform secures the light accent assembly within a downlight fixture.

4. The light accent assembly of claim 3, wherein the collar is operable to removably couple to the LED lamp via a snap-fit engagement.

5. The light accent assembly of claim 4, wherein the trim is integral with the reflector body.

6. The light assembly of claim 4, wherein the collar comprises a set of threads proximate to a bottom end of the collar.

7. The light assembly of claim 6, wherein the collar is operable to removably couple to the reflector body using a threaded engagement.

8. The light assembly of claim 7, wherein the collar includes a locking tab, wherein the locking tab rotationally secures the collar relative to the LED lamp.

9. The light assembly of claim 8, wherein the reflector body includes a lamp vent cover.

10. A method for installing a light accent assembly, comprising:
coupling a light accent assembly to an LED lamp, wherein the light accent assembly comprises:
a collar operable to removably couple to an LED lamp,
a reflector body operable to removably couple to the collar, and
a trim proximate to a bottom of the reflector body, wherein the trim defines a bottom opening through which light generated by the LED lamp is directed; and
installing the LED lamp into a socket within a downlight fixture, and
securing the light accent assembly within the downlight fixture.

11. The method of claim 10, wherein the collar includes an internal shoulder and at least one tab.

12. The method of claim 11, wherein coupling the light accent assembly to an LED lamp includes coupling the LED lamp to the collar via a snap-fit engagement, wherein the snap-fit engagement includes the internal shoulder, the at least one tab, and an integral ring on the LED lamp.

13. The method of claim 12, wherein the step of coupling the light accent assembly to the LED lamp includes coupling the reflector body to the collar.

14. The method of claim 13, wherein coupling the reflector body to the collar includes threadedly engaging the reflector body with the collar.

15. The method of claim 14, wherein the step of coupling the light accent assembly to the LED lamp includes rotationally securing the collar relative to the LED lamp.

16. The method of claim 15, further comprising the step of installing a diffusion lens within the reflector body.

17. The method of claim 16, wherein the diffusion lens includes at least one tab to engage with a lip in the reflector body.

18. A light accent assembly, comprising:
a collar operable to removably couple to an LED lamp, wherein the collar comprises a cylindrical structure that defines a first opening, wherein the first opening directs light from the LED lamp into a reflector body;
the reflector body operable to removably couple to the collar, wherein the reflector directs light received from the LED lamp through a second opening at a bottom of the reflector body; and
a finishing trim positioned proximate the bottom of the reflector body, wherein the finishing trim defines the second opening.

19. The light accent assembly of claim 18, wherein the collar includes a shoulder and at least one tab, wherein the collar is operable to removably couple to the LED lamp via a snap-fit engagement using the shoulder, the at least one tab, and an integral ring on the LED lamp.

20. The light accent assembly of claim 18, wherein the collar includes a first set of threads and the reflector body includes a second set of threads corresponding to the first set of threads.
